(19) United States
(12) Patent Application Publication
(10) Pub. No.: US 2006/0175128 A1
(43) Pub. Date: Aug. 10, 2006

(54) Rescue system for rescuing persons who are in danger in high places

(76) Inventor: Elmar Vonblon, Grav 33 (AT)

Correspondence Address: Markus Ho Fmeister, 2720 SE 2nd Street, Pompano Beach, FL, 33062, US

(21) Appl. No.: 10/705,806

(22) Filed: Nov. 12, 2003

(30) Foreign Application Priority Data
Aug. 11, 2002 (DE) 102 52 044.5

(51) Int. Cl. A62B 35/00

(52) U.S. Cl. 182/3

(57) ABSTRACT

The invention relates to a rescue system for rescuing persons who are in danger in high places, composed of a belt system and a rescue parachute system connected thereto, the release mechanism for the rescue parachute being exposed automatically when the belt system is put on so that it is ensured that the rescue parachute is opened when the wearer jumps or falls from a height.

The present invention relates to a rescue system for persons who are in danger in high places, according to the preamble of patent claim 1.

Persons who are in danger in high places often have no way of rescuing themselves. Depending on the situation, there is a complete lack of appropriate means to permit this, or said means can often not be used to the degree necessary, or can often not be used at all for whatever reason.

A reason for this situation is, inter alia, the fact that rescue means or systems which may be available in some cases are dependent on location and/or power. Means or systems for rescuing persons who are in danger in high places which are independent of location and/or power often exhibit an inadequate degree of reliability.

For example, elevators should not be used in dangerous situations in high buildings as there is a risk of getting stuck. Staircases in or outside the building may become unusable due to fumes. Escape ladders are not provided everywhere by a long way and are more dangerous than outside staircases. Rescue lines for lowering oneself down are anything but safe, if they are provided at all, and are certainly not suitable for untrained persons.

The present invention is therefore based on the object of making available a rescue system for persons who are in danger in high places and which ensures safe rescue while being simple to handle.

The object which is set is achieved by means of the technical teaching of patent claim 1.

If persons in high places are seriously in danger, they can rescue themselves by means of a special rescue system in the form of a rucksack-like belt system with built-in rescue parachute. In order to prepare for the rescue, the belt system must be put on. In order to put on the belt system it is necessary to slip one's legs and arms into the loops provided for them. An abdominal belt or chest belt must then be closed. After this, the rescue system is already ready for a rescue without restriction. The abdominal belt or chest belt is fastened in a receptacle on the belt system within each reach. This fastening is selected such that the closure clip of the abdominal belt or chest belt projects out of which receptacle and can be grasped satisfactorily and easily when the belt system has been put on.

This closure clip must be plugged in a known fashion into the associated belt securing means so that the abdominal or chest belt of the belt system is closed. When an attempt is made to plug the closure clip into the belt securing means, the abdominal or chest belt which has been arranged in the receptacle up to that point must inevitably be pulled out of its receptacle.

In turn, the closure of the receptacle for the abdominal or chest belt inevitably opens and the secondary parachute which is also deposited in it and has the purpose of ensuring that the rescue parachute opens drops out automatically.

This secondary parachute is connected by means of a ripcord to the closure cover of the stowage space for the rescue parachute, said space being arranged on the rear of the belt system. The rescue parachute is located in this stowage space and is held in a hose container. The slight pull on the ripcord causes the closure cover of the stowage space to open and the hose container, with the rescue parachute stowed in it, to drop or slide out of the stowage space.

The rescue parachute is inserted into the hose container in such a way that it can easily be pulled out of it in a reliable way. The resistance of the secondary parachute is sufficient to do this, and is furthermore also suitable for releasing the closure cover from the belt system in all cases. In this respect, consideration has also been paid to the fact that in an emergency the person to be rescued may in certain circumstances fall head first from a height. In this case it is also ensured that the secondary parachute opens the closure cover in all cases and subsequently pulls the rescue parachute out of the hose container so that the latter opens in order to rescue the person in question.

In order to be able to open the rescue parachute reliably and without danger it is necessary for the person in question to jump from a height so that the resistance of the secondary parachute releases the closure cover by means of the ripcord, pulls the hose container out of the stowage space and pulls the hose container down and away from the rescue parachute. At this moment, the rescue parachute is free and fills instantaneously with air so the person to be rescued stops freefalling and changes over into a floating down movement using the rescue parachute, which movement the person to be rescued can influence by means of steering maneuvers.

The person to be rescued can therefore basically jump from a height immediately after the chest belt has been closed. It would be appropriate for the person to previously tighten the abdominal belt or chest belt suitably so that the belt system fits satisfactorily.

However, the function of opening the rescue parachute is already ensured from the time when the closure clip for the abdominal or chest belt is pulled, that is to say even before the abdominal or chest belt is closed, it being possible to assume that the person in question will do this before he/she jumps from a height.

This description applies to a situation in which the person in question does not use some other device which is provided to open the rescue parachute more quickly. In the previously described variant, a distance of approximately 20 m to 25 m has been determined for the freefalling distance in jump trials which have been carried out. This distance can be shortened by using further resources. It is thus provided for the person in question, or even a further person, to attach a fastening loop, arranged on the ripcord, to a suitable anchoring means so that the freefalling distance up to the point when the necessary resistance is reached in order to open the closure cover is eliminated.

For this purpose a further resource is arranged. This is a snap action hook. This may be hooked into the fastening loop on the ripcord if necessary after said line has been wound around a suitable object to anchor it. The snap action hook can logically also be anchored itself at a suitable location in order to open the closure cover immediately.

Irrespective of the manner in which the person to be rescued jumps or falls from a height, it is ensured in all cases that the rescue parachute is opened reliably and automatically. For this purpose, it is to be noted at this point that basically even persons who have lost consciousness can be rescued from a high place by means of such a rescue system. The rescue system is designed in such a way that the rescue parachute opens in any circumstance regardless of the position in which the rescue system is located, and the rescue parachute allows the load fastened to it to float downward at the appropriate falling speed.

If this load were an unconscious person, the only problems encountered would be that the person cannot use appropriate steering movements to avoid obstacles which may appear, or may have a hard landing under certain circumstances. However, these problems are certainly acceptable in comparison with the risk of possibly not surviving without the rescue system according to the invention. In this way the group of persons to be rescued would thus be extended even to persons who would no longer be in a position to save themselves for whatever reasons.

The ripcord to which the closure cover is fastened is positioned within the stowage space for the rescue parachute in such a way that the closure cover is torn open no matter how the belt system is orientated during the freefall. This is achieved by virtue of the fact that the ripcord is looped in the interior of the belt system, that is to say in the stowage space for the rescue parachute, in such a way that it is permanently connected to the closure cover at least on one side and is conducted freely approximately opposite or diagonally with respect to this fastening point. In the simplest case this is done within the stowage space. That is to say for example the side of the ripcord which is fastened to the closure cover lies on the inside at the top when the person to be rescued is in an upright position, and the ripcord is in turn guided inside to the lower end of the closure cover and guided out of it. This ensures that the closure cover is opened in all cases irrespective of whether the person to be saved jumps head first or legs first so that the hose container with the rescue parachute stowed in it is exposed and the rescue parachute can then slide out of the hose container and open.

In summary it is possible to note at this point that in an emergency a ripcord which is located on the belt system which forms the safety system, or a rope/cable is securely mounted on an object or a suitable anchoring in or on the building. A person can then jump from the building. After several meters, the parachute is pulled out of the belt system, in which case it can open immediately.

If the cord is not satisfactorily fastened to the building, the system will remain inoperative without further safety measures. However, this function of activating the parachute can be ensured by attaching a small parachute (braking parachute). The opening mechanism for the rescue parachute then either remains hanging from the building, or alternatively floats down from it after the rescue parachute 11 has opened using the small secondary parachute 5.

In order to ensure the operativeness, a suitable closure, for example a touch and close fastener of a container is opened or disconnected as the abdominal and/or chest belt closes, after which a secondary parachute for releasing the rescue parachute with the snap action hook and the fastening loop drops to the ground from the respective container and as a result the automatic rescue system is now also activated without further maneuvers.

Starting from this time it is ensured in all cases that the rescue parachute is opened when the wearer jumps or falls from a height. The system is primarily developed for a situation in which persons wish to rescue themselves and in the stressful situation do not fasten the ripcord with the loop provided for it and/or with the snap action hook, for opening the rescue parachute as early as possible, or else do not fasten it correctly, or perhaps can no longer fasten it owing to whatever circumstances.

The container in which the abdominal and/or chest belt is stowed together with the release mechanism of the rescue parachute can be composed of woven fabric, plastic or the like. The closure of the container can be formed by means of a touch and close fastener, a zip fastener, pins or other closure possibilities. The container can also be composed of two or more shells which are plugged one into the other.

The release mechanism of the rescue parachute is composed essentially of the ripcord at one end of which a fastening loop is arranged.

Furthermore, there is a secondary parachute arranged on the ripcord which ensures in all cases that the rescue parachute is opened as the wearer jumps or falls from a height. Furthermore, a snap action hook is arranged on the ripcord in order to facilitate anchoring the ripcord. Furthermore, the ripcord is connected to the closure cover of the rescue system in the form of the belt system behind which the hose container is inserted, for example, in a zigzag fashion, and in which the rescue parachute is held.

By means of a pull on the ripcord, the closure cover is therefore opened or pulled off so that the closure container with the rescue parachute located in it slips out of the belt system. The pull on the ripcord is then of such a magnitude in all cases that the rescue parachute slips out of the hose container and opens so that the person to be rescued hangs in the rescue parachute and floats safely to the ground.

The rescue device, that is to say the rescue parachute, which may then either be a conventional round cap or a controllable parachute, is packed in a hose form and pulled into its hose container. The attachment lines of the parachute are accommodated in the hose container. The rescue device and the hose container are then packed into the belt system using a zigzag method, and closed with the closure cover.

In a normal situation, the fastening loop is fastened in the building or about a component which is fixedly fastened to the building. The fastening may be carried out by inserting a table leg or wrapping cord around the table leg, using the snap action hook for securing purposes. The person can then jump out of the window, door or off the roof etc. In the process, the ripcord is tightened and the closure cover disconnected from the belt system. The lid then in turn pulls out the hose container together with the parachute. It then pulls the parachute completely out of the hose container and the parachute can unfold. The release mechanism with fastening loop, braking parachute, snap action hook, closure cover and hose container always remain one unit and remain together by virtue of the connection to the ripcord.

The secondary parachute has a function of pulling the rescue parachute out of its hose container (packing bag) when the ripcord is not inserted, or when it becomes detached from the securing point or fastening point of this secondary parachute.

The secondary parachute may be of any conceivable shape, the decisive factor is that as the acceleration increases, a resistance is generated which is so large that this component generates sufficient force to open the closure cover and expose the main parachute.

If the attachment loop should become loose or if it was not securely connected to the building, the person to be rescued would fall in an unbraked fashion. In this situation, the secondary parachute which increases its force at every meter of the drop until it opens the closure cover then acts and pulls out the hose container. This opening method is based on air resistance and therefore requires neither a battery, altimeter or any additional resources.

The parachute is preferably a Rogallo system which can additionally be controlled by pulling the lines. The parachute therefore always moves away from the jumping location.

The packing method is configured such that the hose container is pulled over the rescue parachute, and the hose container is then packed into the belt system using a zigzag method.

The present invention will now be explained in more detail below with reference to the appended drawings. Further individual details on said invention are disclosed by means of the description of the individual figures. In the drawing:

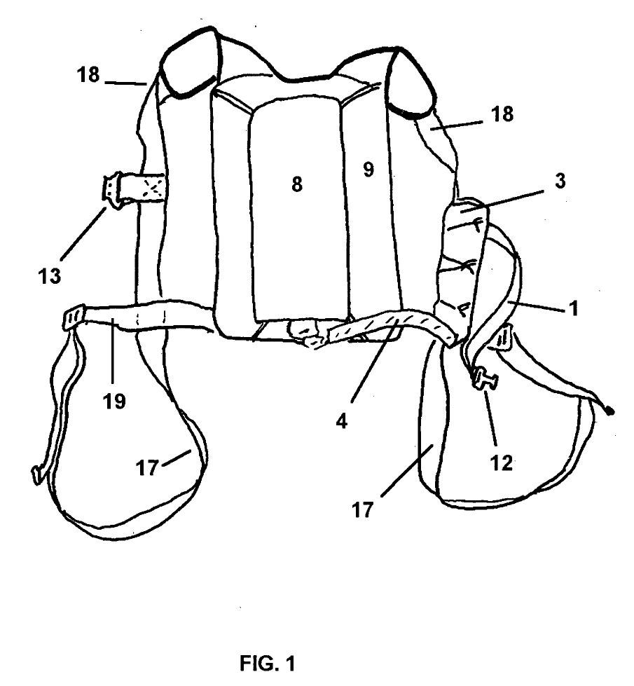

FIG. 1 shows a plan view, from behind, of the rescue system according to the invention or else safety system in the form of a belt system on which a rescue parachute is also accommodated on the wearer's back;

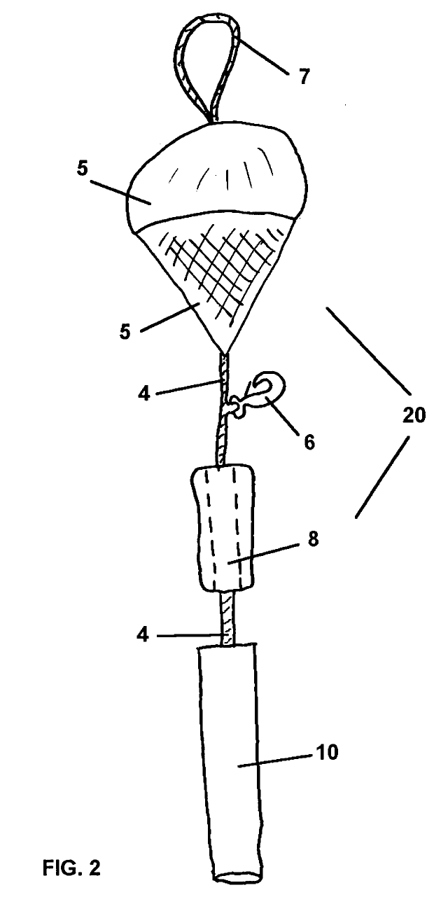

FIG. 2 shows the release mechanisms for the rescue parachute;

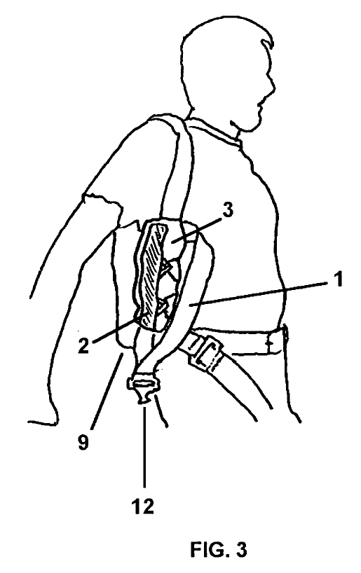

FIG. 3 shows the rescue system which has already partially been put on by a person, with the main emphasis on the safety mechanisms;

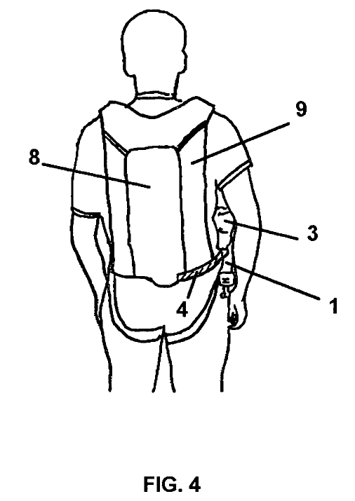

FIG. 4 shows the rescue system which has been put on by a person, in a rear view;

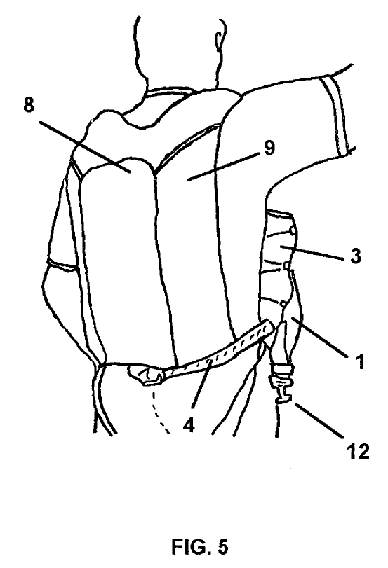

FIG. 5 shows a rear view of the rescue system in which the chest belt has not yet been closed;

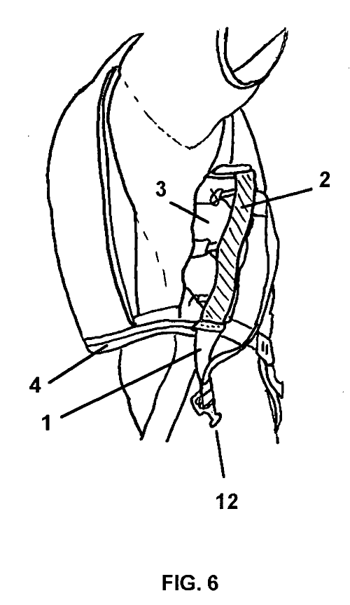

FIG. 6 shows a side view of the rescue system in which the chest belt has also not yet been closed;

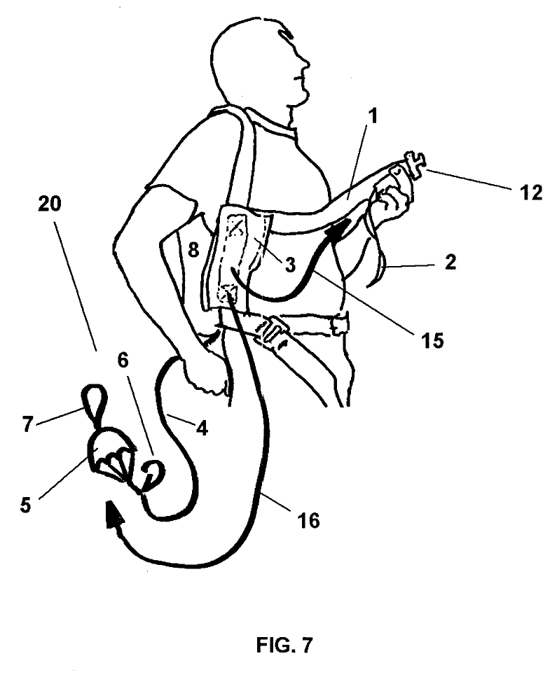

FIG. 7 shows an oblique front view of the rescue system in which the chest belt has just been put into position for closing, the necessary objective on the chest belt exposing the safety mechanism for the rescue parachute;

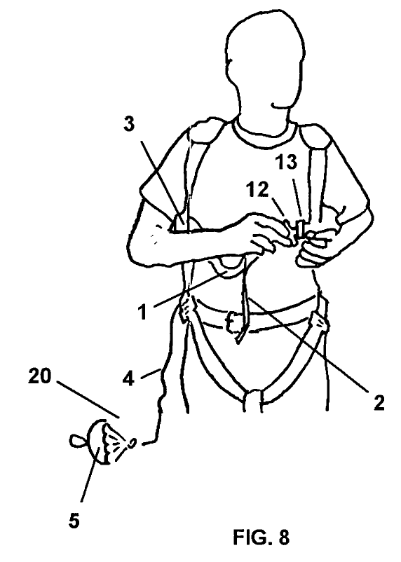

FIG. 8 shows the closing of the chest belt and of the rescue system with exposed safety mechanism for the rescue parachute;

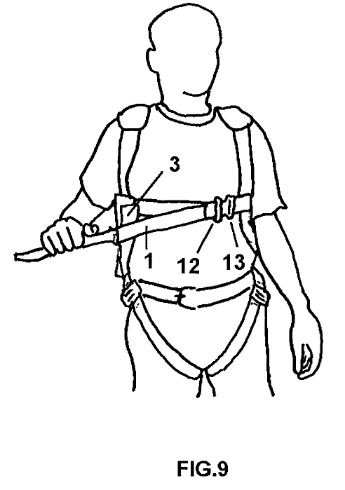

FIG. 9 shows the tightening of the chest belt for the rescue system;

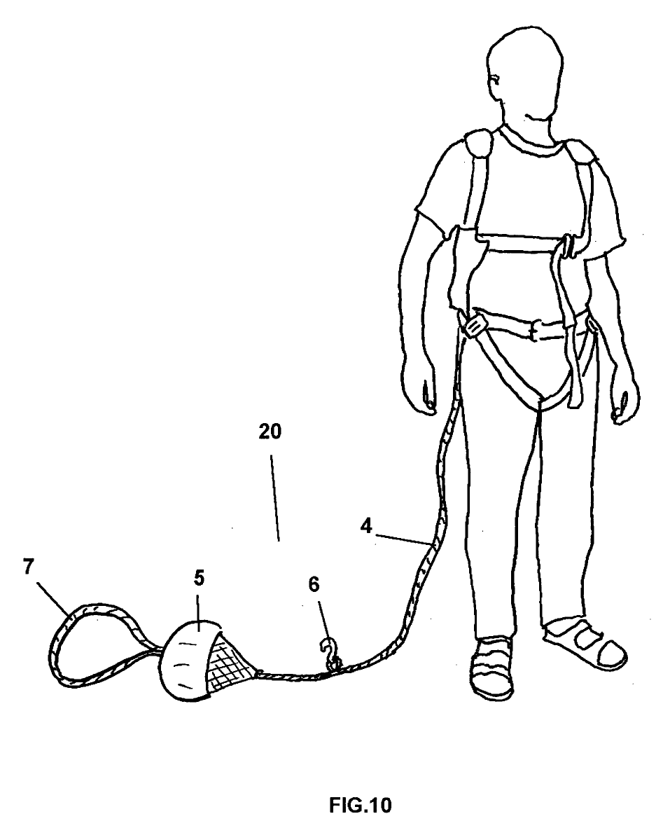

FIG. 10 shows the rescue system in a state in which it has been put on by a person, with an exposed safety mechanism for releasing the rescue parachute;

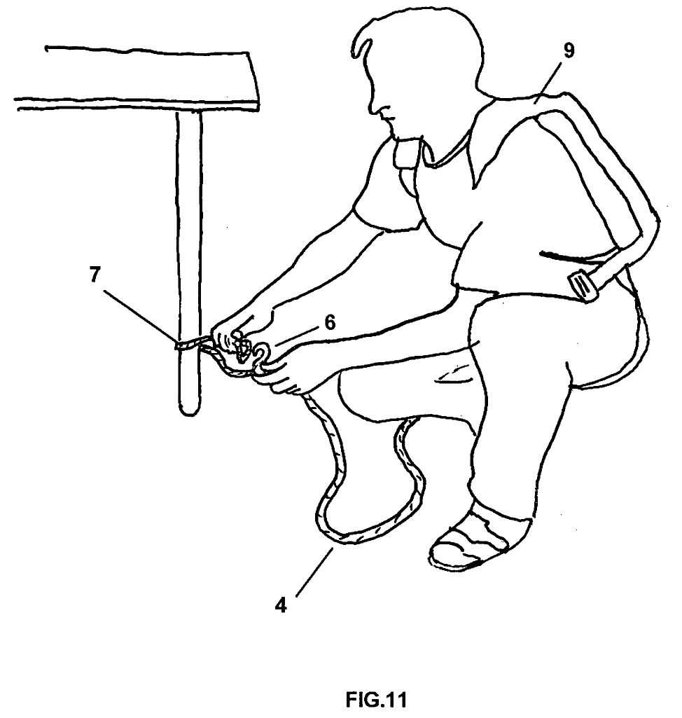

FIG. 11 shows the fastening of the safety mechanism for the earliest possible release of the rescue parachute of the rescue system;

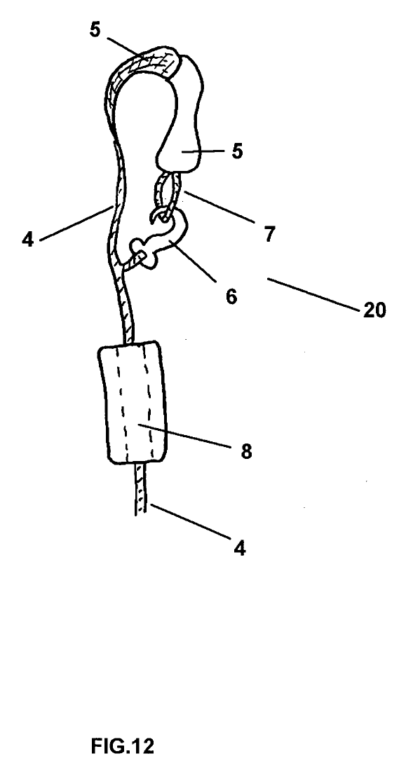

FIG. 12 shows a loop of the safety mechanism which is closed by a snap action hook and a loop, in an exemplary view;

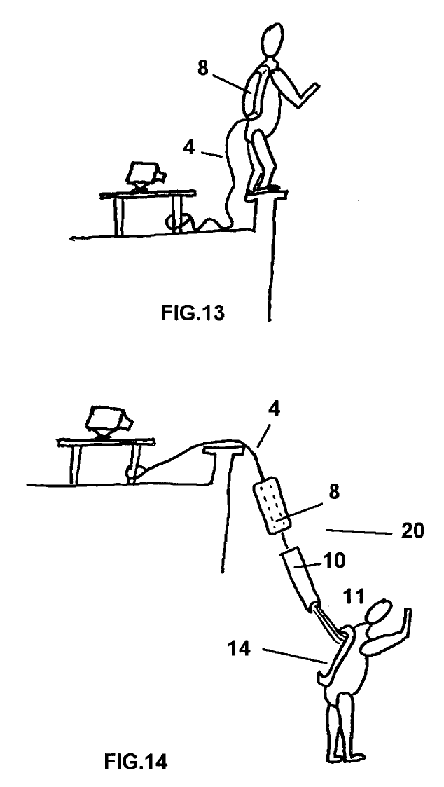

FIG. 13 shows a person who has put on the rescue system according to the invention, the release mechanism having been fastened around a possible anchor according to FIGS. 11 and 12;

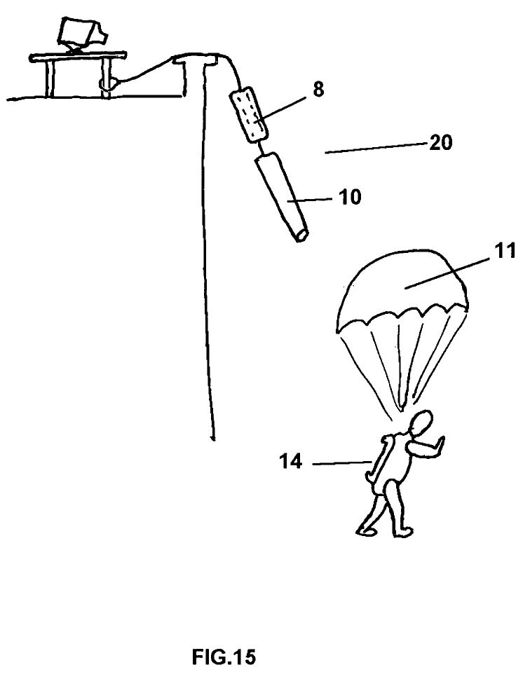

FIG. 14 shows the person jumping from a height, the release mechanism pulling the rescue parachute out of the rescue system which the person has put on in order to intercept the freefall;

FIG. 15 shows the person with the rescue parachute opened;

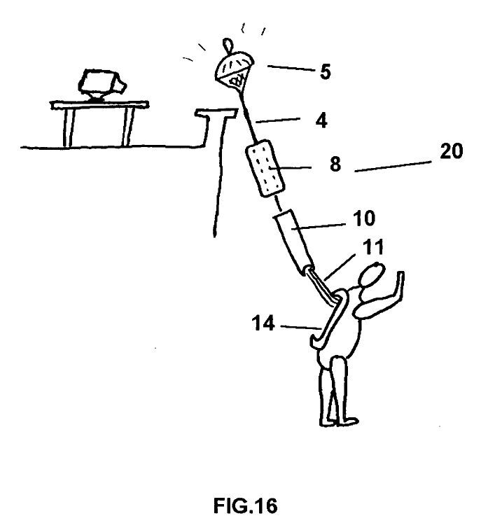

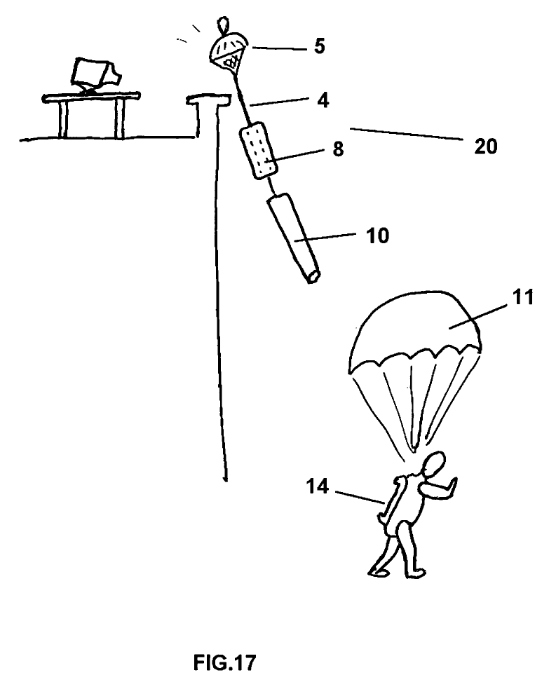

FIG. 16 shows a further variant of the opening of the rescue parachute of the rescue system according to the invention in which, in accordance with FIG. 14, the rescue parachute is also in the process of being pulled out of the rescue system, and

FIG. 17 also shows the person to be rescued with the rescue parachute opened, but as a result of the release of the rescue parachute using the secondary parachute.

FIG. 1 shows the rescue system according to the invention in the form of the strap system 9 which is composed of a back part in which, in an application-related situation, a rescue parachute is held in an appropriately prepared state, which back part is closed by means of a closure cover 8. In order to be able to put on the strap system 9 appropriately, it has shoulder and arm straps 18 as well as leg straps 17. The hip strap is arranged in the lower region. The rescue system or else safety system in the form of the strap system 9 is then put on in such a way that the wearer climbs into the two leg straps and the two shoulder and arm straps are crossed over in a manner of a harness so that the strap system 9 itself comes to rest on the back in the manner of a safety harness, the legs and arms of the body of the person to be rescued being inserted in the respective receptacles. In order to close the system it is necessary to anchor the abdominal/chest strap 1 to the closure clip 12 in the strap securing means 13 in such a way that the abdominal/chest strap comes to rest just before the abdomen or the chest. Said strap can then be tightened, if necessary.

In order to plug the closure clip 12 into the strap securing means 13 it is necessary to pull the abdomen/chest strap 1 out of its receptacle 3 which may also be, for example, in the shape of a container as the abdomen/chest strap is inserted into this receptacle in such a way that only the closure strap 12 projects out of it at one point. When the wearer pulls on the abdomen/chest strap, the receptacle for the abdomen/chest strap is then opened or its cover removed so that a safety mechanism or release mechanism for the rescue parachute is exposed and drops out of the receptacle.

Starting from this time it is already ensured that the rescue parachute is opened when the wearer jumps or falls from a height.

The ripcord 4, which is part of the release or safety mechanism for the rescue parachute, is inserted, for the most part, into the receptacle 3 together with the abdomen/chest strap, using the appropriate means. As soon as the abdomen/chest strap is removed from the receptacle 3, the major part of the release or safety mechanism located in it drops out of the receptacle 3 so that, as is clearly apparent in FIG. 10, said mechanism is then exposed. The remaining part of the ripcord 4 which is not accommodated in the receptacle 3 runs outside the receptacle 3 to the rear side of the strap system 9 and is securely connected to the closure cover 8. By means of a pull on the ripcord 4, the closure cover 8 is disconnected from the strap system 9 so that the hose container 10 arranged under it, with the rescue parachute 11 arranged in it slips out. A further slight pulling effect on the ripcord causes the hose container 10 to be pulled off from the rescue parachute 11 so that the latter can be used immediately.

FIG. 2 shows the release or safety mechanism for the rescue parachute. The latter is composed essentially of the ripcord 4 which has a fastening loop 7 at one end. This fastening loop can be optionally wound around any anchor. If it is not possible to fasten the fastening loop 7 anywhere on its own, a snap action hook 6 is additionally arranged on the ripcord 4 in order to permit the ripcord 4 to be fastened, which snap action hook 6 can be used, together with the fastening loop 7, to form a noose which can be laid around any object or anchor. The example of a corresponding illustration can be found in FIGS. 11, 13 to 15. In these figures, a table leg has been illustrated as an appropriate counter bearing or anchor. FIG. 12 shows how the snap action hook 6 can be connected to the fastening loop 7 in order to form a noose which can be laid around a suitable anchor.

FIG. 3 shows the rescue system according to the invention in the form of the strap system 9 in an oblique side view from below. It is important here that the receptacle 3 is illustrated in such a way that part of the chest strap 1 is arranged in the receptacle 3 in such a way that only a short end projects out of it, to which short end the closure clip 12 is fastened. In order to be able to click the abdominal/chest strap 1 with the closure clip 12 into the strap securing means 13, it is necessary to pull on the abdominal/chest strap 1 so that the touch and close fastener illustrated in this case is opened as a closure of the receptacle or of the container 3. As a result, the receptacle or the container 3 in which the major part of the ripcord 4 with the remaining part of the release mechanism for the rescue parachute is accommodated, also opens so that said parts drop out and are exposed, as illustrated in FIG. 10. However, in the illustration in FIG. 3, these accessories are still accommodated in the receptacle 3 as prepared.

FIG. 4 shows the rescue system according to the invention in the form of the strap system 9 in the view from behind when a person has put on such a strap system. Here, the closure cover 8 on the strap system 9 can be seen anchored in the centre of the back.

The figure also clearly shows the part of the ripcord 4 which extends away from the receptacle 3 to the closure cover 8 which is fastened to the ripcord 4. It is also possible to see the abdominal/chest strap 1 which, according to the illustration in FIG. 3, is still accommodated in the receptacle 3 before the person who is wearing the strap system pulls it out of the receptacle and thus releases the release mechanism for opening the rescue parachute.

FIG. 5 shows the situation in FIG. 4 again, but here an oblique side view from the rear is illustrated so that the receptacle 3 with the abdominal/chest strap 1 hanging out of it and the ripcord 4 projecting out of it can be seen more satisfactorily, as has just been described in the function with respect to FIG. 4.

FIG. 6 shows in turn the same situation but viewed directly from the side from below. Here it is very clearly apparent that the closure in the form of the touch and close fastener 2 for the receptacle 3 is still in fact holding the receptacle to be closed, and the abdominal/chest strap 1 and the ripcord 4 at its rear end project out in the short way intended, as is provided for the preparation for use. The closure clip 12 hangs down from the abdominal/chest strap 1.

FIG. 7 then shows the process in which a person to be rescued has removed the abdominal/chest strap 1 from the receptacle 3, the closure in the form of the touch and close fastener 2 being released from the receptacle or the container 3 and hanging downward at the end of the abdominal/chest strap in the vicinity of the closure clip 12.

Here, it is important to note that the receptacle 3 is then opened so that the release mechanism for the rescue parachute composed of the ripcord 4 and having the fastening loop 7, the secondary parachute 12 and the snap action hook 6, is then exposed and lies, for example, on the ground. Starting from this time, it is ensured in all cases that when the wearer jumps or falls from a height the rescue parachute is pulled out of the strap system 9 and opens. The dropping of the release mechanism for the rescue parachute is illustrated by means of the arrow 16, and it takes place simultaneously with the movement of the person for the exposure of the abdominal/chest strap, illustrated by the arrow 15.

In accordance with FIG. 8, the person to be rescued then closes the abdominal/chest strap by plugging the closure clip 12 into the strap securing means 13. The release mechanism for the rescue parachute lies next to the person and hangs down from the strap system 9, on the closure cover 8 (shown in FIG. 7) at the rear of the person to be rescued.

FIG. 9 illustrates how the abdominal/chest strap can be tightened if necessary. Here, the closure clip 12 has previously been clicked into the strap securing means 13 so that the abdominal/chest strap 1 is correspondingly positioned around the abdomen or the chest of the person to be rescued. From this point in time, the person to be rescued can jump or fall from a height and it is ensured in all cases that the rescue parachute will open. This is the case even if the person to be rescued is not completely conscious.

FIG. 10 shows the situation according to the illustration in FIG. 9 in which the person to be rescued has tightened the abdomen/chest strap, it being clearly shown here that the release mechanism for the rescue parachute is composed essentially of the ripcord 4 and has the fastening loop 7, the secondary parachute 5 and the snap action hook 6.

FIG. 11 shows the variant in which the person to be rescued still has sufficient time either just to thread the fastening loop 7 under a table leg or, as illustrated in FIG. 11, form a loop, formed according to the illustration in FIG. 12, by wrapping the fastening loop 7 around the table leg and clipping the snap action hook 6 into said fastening loop 7.

FIG. 13 shows a situation of the person to be rescued, the loop having already been fastened around the table leg and the person standing on a wall projection before jumping down.

FIG. 14 shows a situation after the person has jumped from a height. The ripcord 4 becomes taut, tears the closure cover 8 from the rear of the strap 9 and pulls the hose container 10, also attached to the ripcord 4, out of the stowage space 14 of the strap system 9 so that the rescue parachute 11 slips out of the strap system 9 from its state in which it is folded up in a zigzag shape. In FIG. 14 it is shown that the hose container 10 is already slipping down from the rescue parachute 11 so that the latter is then exposed in order to catch the person jumping from a height. This state is illustrated in FIG. 15.

FIG. 15 shows that the hose container 10 has released the rescue parachute 11 and the person to be rescued then floats down from a height on said rescue parachute 11.

FIG. 16 then shows the variant in which the person to be rescued has either failed to fasten the ripcord about any anchoring means or this anchoring operation was not carried out sufficiently well so that when the wearer jumps from a height the secondary parachute 5 inflates and exerts a pull on the ripcord 4 so that the closure cover 8 is torn off the rear side of the strap system 9, after which in turn, as already described in the previous embodiment, the hose container 10 is pulled out of the stowage space 14 of the strap system 9, in which case only the cords of the rescue parachute 11 can then also be seen here.

In the illustration in FIG. 17, the person has then been brought to such a safe position, also by virtue of the opened rescue parachute, that said person can now float to the ground. In this variant of the rescue means it has been shown experimentally to take approximately two seconds until the rescue parachute 11 has opened and caught the person in their freefall. The release mechanism of the ripcord 4, secondary parachute 5, closure cover 8 and hose container 10 floats downward in this case on the secondary parachute 5. In the process which was previously described, this device remains hanging from the anchoring means.

1. A rescue system for rescuing persons who are in danger in high places, composed of a belt system and a rescue parachute system connected thereto, wherein the release mechanism (20) for the rescue parachute (11) is exposed automatically when the belt system (9) is put on so that it is ensured that the rescue parachute (11) is opened when the wearer jumps or falls from a height.

2. The rescue system as claimed in claim 1, wherein the release mechanism (20) of the rescue parachute (11) is connected to the belt system (9) in such a way that it is not possible to put on the belt mechanism completely without the release mechanism (20) being exposed.

3. The rescue system as claimed in one of claims 1 or 2, wherein the release mechanism (20) is stowed, together with at least part of the abdominal/chest belt (1), in a receptacle (3).

4. The rescue system as claimed in one of claims 1 to 3, wherein, by pulling on the abdominal/chest belt (1) or the closure clip (12) fastened thereto, for the purpose of locking the closure clip (12) to the belt securing means (13) when the abdominal/chest belt (1) is put on, the receptacle (3) in which the abdominal/chest belt (1) is deposited is opened to such an extent that the release mechanism (20) which is also arranged in it drops out of it and can be used immediately.

5. The rescue system as claimed in one of the preceding claims, wherein the release mechanism (20) is composed of a ripcord (4) to which a fastening loop (7), a snap action hook (6), a secondary parachute (5), the closure cover (8) and the hose container (10) for holding the rescue parachute (11) are fastened.

6. The rescue system as claimed in one of the preceding claims, wherein the rescue parachute (11) is released by pulling on the ripcord (4) so that it catches the person to be rescued in freefall and allows him/her to float to the ground.

7. The rescue system as claimed in one of the preceding claims, wherein the pull on the line (4) is exerted by anchoring the line (4) to a corresponding anchoring point as a restraint system for the release mechanism (20) as the wearer jumps or falls from a height.

8. The rescue system as claimed in one of claims 1 to 6, wherein the pull on the ripcord (4) for activating the release mechanism (20) is exerted by the fact that the secondary parachute (12) exerts such a large air resistance as the wearer jumps or falls from a height that the rescue parachute is opened.

9. The rescue system as claimed in one of claims 1 to 7, wherein the ripcord (4) is anchored at a correspondingly suitable point by means of the fastening loop (7) and/or the snap action hook (6).

10. The rescue system as claimed in one of the preceding claims, wherein the rescue parachute is arranged in a hose container (10) in the stowage space (14) of the belt system (9) and is prepared for the jump with the closure cover (8) in the stowed state.

11. The rescue system as claimed in one of the preceding claims, wherein the hose container (10) is stowed in the stowage space (14) of the belt system (9) in zigzag fashion.

12. The rescue system as claimed in one of the preceding claims, wherein the rescue parachute is a controllable parachute.

13. The rescue system as claimed in one of claims 1 to 11, wherein the rescue parachute (11) is a non-controllable rescue parachute.
